(19) United States
(12) Patent Application Publication
(10) Pub. No.: US 2017/0193601 A1
(43) Pub. Date: Jul. 6, 2017

(54) SYNTHETIC ORDER REALLOCATION TOOL

(71) Applicant: TRADING TECHNOLOGIES INTERNATIONAL, INC., CHICAGO, IL (US)

(72) Inventors: Iliar MANGUTOV, Hinsdale, IL (US); Sanju VARGHESE, Chicago, IL (US); Patricia A. MESSINA, Chicago, IL (US); Sun Joong YOO, Chicago, IL (US)

(21) Appl. No.: 14/984,582

(22) Filed: Dec. 30, 2015

(51) Int. Cl. G06Q 40/04

(52) U.S. Cl. CPC G06Q 40/04

(57) ABSTRACT

An allocation manager may be implemented to reallocate the order quantities that are pending in an order queue at different exchanges according to a definition of a trading strategy. To reallocate the order quantities across the different exchanges, a minimum position-in-queue value for each leg in the trading strategy may be determined by the allocation manager. The minimum position-in-queue value may be the minimum or target value to be pending at an order queue for each leg of the trading strategy. A quantity allocation amount may be determined for one or more of the legs of the trading strategy to reallocate a quantity of a tradeable object from one exchange to another to meet the minimum position-in-queue value at each exchange. A quantity allocation amount may be communicated to each exchange to transfer the quantity allocation amount between the exchanges.

### BACKGROUND

An electronic trading system generally includes a trading device in communication with an electronic exchange. The trading device receives information about a market, such as prices and quantities, from the electronic exchange. The electronic exchange receives messages, such as messages related to orders, from the trading device. The electronic exchange attempts to match quantity of an order with quantity of one or more contra-side orders.

Trading devices, in turn, may be configured to implement and/or execute one or more trading applications. A trading application may be used to define a trading strategy having one or more legs. The defined legs of a trading strategy may relate to different tradeable objects traded at, for example, different exchanges.

### BRIEF DESCRIPTION OF THE FIGURES

Certain embodiments are disclosed with reference to the following drawings.

FIG. 1 illustrates a block diagram representative of an example electronic trading system in which certain embodiments may be employed.

FIG. 2 illustrates a block diagram of another example electronic trading system in which certain embodiments may be employed.

FIG. 3 illustrates a block diagram of an example computing device which may be used to implement the disclosed embodiments.

FIG. 4 illustrates a block diagram of a trading strategy, which may be employed with certain disclosed embodiments.

FIG. 5 illustrates a block diagram of another example electronic trading system in which certain embodiments may be employed.

FIGS. 6A, 6B, and 6C-6D illustrate example displays of market data indicating an allocation of order quantities and position-in-queue values for different legs of a trading strategy.

FIGS. 7A and 7B illustrate example displays of market data across different legs of a trading strategy at different times.

FIG. 8 illustrates an example method for reallocating order quantities between exchanges.

FIG. 9 illustrates another example method of reallocating order quantities between exchanges.

Certain embodiments will be better understood when read in conjunction with the provided figures, which illustrate examples. It should be understood, however, that the embodiments are not limited to the arrangements and instrumentality shown in the attached figures.

### DETAILED DESCRIPTION

Trading strategies may be defined for submitting trade orders to one or more electronic exchanges. The trading strategies may include multiple legs, each leg corresponding to a tradeable object at an electronic exchange. The trade orders may be submitted at different exchanges to create a synthetic spread. Each trade order may include order quantities that are matched at different rates at each electronic exchange.

An allocation manager may be implemented to reallocate the order quantities at each exchange to take advantage of exchanges that may be matching orders at a higher rate or that may have a greater available order quantity. In order to reallocate the order quantities across the different exchanges, the tradeable objects at each exchange may be determined to be fungible. If the tradeable objects are fungible at each exchange, a minimum position-in-queue value for each leg in the trading strategy may be determined. The minimum position-in-queue value may be the minimum or target value to be pending in an order queue for each leg of the trading strategy. A quantity allocation amount may be determined for one or more of the legs of the trading strategy to reallocate a quantity of a tradeable object from one exchange to another to meet the minimum position-in-queue value at each exchange. A quantity allocation amount may be communicated to each exchange to transfer the quantity allocation amount between the exchanges and meet the minimum position-in-queue value at each exchange.

Although this description discloses embodiments including, among other components, software executed on hardware, it should be noted that the embodiments are merely illustrative and should not be considered as limiting. For example, it is contemplated that any or all of these hardware and software components may be embodied exclusively in hardware, exclusively in software, exclusively in firmware, or in any combination of hardware, software, and/or firmware. Accordingly, certain embodiments may be implemented in other ways.

### I. Brief Description of Certain Embodiments

Systems, methods, and an apparatus are described herein for allocating trade order quantities for a synthetic spread. As described herein, an allocation manager may receive a definition for a trading strategy. The definition may include a plurality of legs. Each of the plurality of legs may correspond with a tradeable object offered at a first exchange. Each of the plurality of legs may be part of a synthetic spread. The allocation manager may determine that the tradeable object corresponding to at least one leg specified in the trading strategy is fungible with a second tradeable object offered at a second exchange. The allocation manager may start a timer when a position-in-queue value associated with one of the legs of the trading strategy is zero. When the timer has elapsed, the allocation manager may determine a minimum position-in-queue value for each leg in the trading strategy. The allocation manager may determine a quantity allocation amount for at least one of the legs of the trading strategy based on the determined minimum position-in-queue value and may communicate the determined quantity allocation amount to the first exchange and the second exchange. The communication may include an indication to transfer the determined quantity allocation amount between the first exchange and the second exchange.

The allocation manager may determine that at least one of the minimum position-in-queue value or the quantity allocation amount is greater than a threshold before communicating the determined quantity allocation amount to the first exchange and the second exchange.

Determining the quantity allocation amount may include subtracting an available order quantity for the at least one of the legs of the trading strategy. Determining the minimum position-in-queue value may include calculating a sum of a position-in-queue value for each of the legs of the trading strategy, calculating a sum of an available contra-side order quantity for each of the legs of the trading strategy, calculating a difference between the sum of the position-in-queue values and the sum of the available contra-side order quantities, and calculating the minimum position-in-queue value by dividing the difference between the sum of the position-in-queue values and the sum of the available contra-side order quantities by a number of legs in the trading strategy.

The allocation manager may determine that the tradeable object corresponding to the at least one leg specified in the trading strategy is fungible with a third tradeable object offered at a third exchange. The allocation manager may determine the quantity allocation amount for at least two of the legs of the trading strategy based on the determined minimum position-in-queue value. The allocation manager may communicate the determined quantity allocation amount to at least two of the first exchange, the second exchange, and the third exchange.

The allocation manager may be located at a trading device. The trading device may be a trading terminal and/or a trading server. The allocation manager may be executed, from memory, by a processor at a computing device.

The allocation manager may determine a transaction cost associated with transferring the determined quantity allocation amount between the first exchange and the second exchange. The quantity allocation amount may be communicated to the first exchange and the second exchange when the determined transaction cost is less than a threshold.

The allocation manager may determine an available order quantity for the tradeable object at the at least one of the first exchange or the second exchange and may determine the quantity allocation amount based on the available order quantity. The quantity allocation amount may be determined when a triggering criteria is identified. The triggering criteria may be a position-in-queue value reaching zero for at least one of the legs of the trading strategy. The allocation manager may start a timer when the triggering criteria is identified and may determine whether to adjust the quantity allocation amount after the timer has elapsed.

### II. Example Electronic Trading System

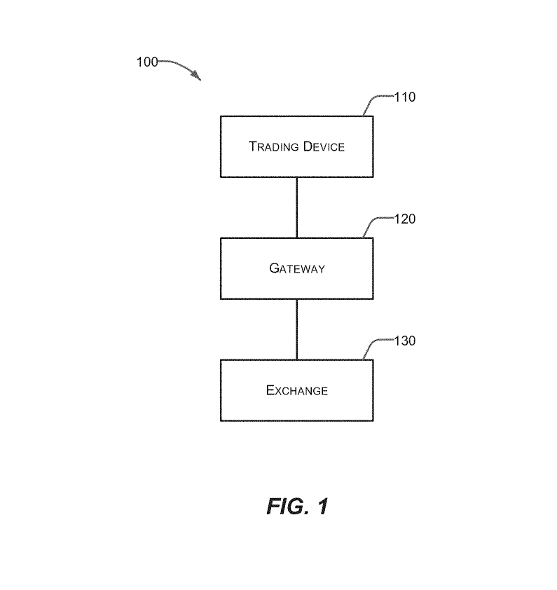

FIG. 1 illustrates a block diagram representative of an example electronic trading system 100 in which certain embodiments may be employed. The system 100 includes a trading device 110, a gateway 120, and an exchange 130. The trading device 110 is in communication with the gateway 120. The gateway 120 is in communication with the exchange 130. As used herein, the phrase “in communication with” encompasses direct communication and/or indirect communication through one or more intermediary components. The exemplary electronic trading system 100 depicted in FIG. 1 may be in communication with additional components, subsystems, and elements to provide additional functionality and capabilities without departing from the teaching and disclosure provided herein.

In operation, the trading device 110 may receive market data from the exchange 130 through the gateway 120. A user may utilize the trading device 110 to monitor this market data and/or base a decision to send an order message to buy or sell one or more tradeable objects to the exchange 130.

Market data may include data about a market for a tradeable object. For example, market data may include the inside market, market depth, last traded price (“LTP”), a last traded quantity (“LTQ”), or a combination thereof. The inside market refers to the highest available bid price (best bid) and the lowest available ask price (best ask or best offer) in the market for the tradeable object at a particular point in time (since the inside market may vary over time). Market depth refers to quantities available at price levels including the inside market and away from the inside market. Market depth may have “gaps” due to prices with no quantity based on orders in the market.

The price levels associated with the inside market and market depth can be provided as value levels which can encompass prices as well as derived and/or calculated representations of value. For example, value levels may be displayed as net change from an opening price. As another example, value levels may be provided as a value calculated from prices in two other markets. In another example, value levels may include consolidated price levels.

A tradeable object is anything which may be traded. For example, a certain quantity of the tradeable object may be bought or sold for a particular price. A tradeable object may include, for example, financial products, stocks, options, bonds, future contracts, currency, warrants, funds derivatives, securities, commodities, swaps, interest rate products, index-based products, traded events, goods, or a combination thereof. A tradeable object may include a product listed and/or administered by an exchange, a product defined by the user, a combination of real or synthetic products, or a combination thereof. There may be a synthetic tradeable object that corresponds and/or is similar to a real tradeable object.

An order message is a message that includes a trade order. A trade order may be, for example, a command to place an order to buy or sell a tradeable object; a command to initiate managing orders according to a defined trading strategy; a command to change, modify, or cancel an order; an instruction to an electronic exchange relating to an order; or a combination thereof.

The trading device 110 may include one or more electronic computing platforms. For example, the trading device 110 may include a desktop computer, hand-held device, laptop, server, a portable computing device, a trading terminal, an embedded trading system, a workstation, an algorithmic trading system such as a “black box” or “grey box” system, cluster of computers, or a combination thereof. As another example, the trading device 110 may include a single or multi-core processor in communication with a memory or other storage medium configured to accessibly store one or more computer programs, applications, libraries, computer readable instructions, and the like, for execution by the processor.

As used herein, the phrases “configured to” and “adapted to” encompass that an element, structure, or device has been modified, arranged, changed, or varied to perform a specific function or for a specific purpose.

By way of example, the trading device 110 may be implemented as a personal computer running a copy of X_TRADER®, an electronic trading platform provided by Trading Technologies International, Inc. of Chicago, Ill. (“Trading Technologies”). As another example, the trading device 110 may be a server running a trading application providing automated trading tools such as ADL®, AUTOSPREADER®, and/or AUTOTRADER™, also provided by Trading Technologies. In yet another example, the trading device 110 may include a trading terminal in communication with a server, where collectively the trading terminal and the server are the trading device 110.

The trading device 110 is generally owned, operated, controlled, programmed, configured, or otherwise used by a user. As used herein, the phrase “user” may include, but is not limited to, a human (for example, a trader), trading group (for example, a group of traders), or an electronic trading device (for example, an algorithmic trading system). One or more users may be involved in the ownership, operation, control, programming, configuration, or other use, for example.

The trading device 110 may include one or more trading applications. As used herein, a trading application is an application that facilitates or improves electronic trading. A trading application provides one or more electronic trading tools. For example, a trading application stored by a trading device may be executed to arrange and display market data in one or more trading windows. In another example, a trading application may include an automated spread trading application providing spread trading tools. In yet another example, a trading application may include an algorithmic trading application that automatically processes an algorithm and performs certain actions, such as placing an order, modifying an existing order, deleting an order. In yet another example, a trading application may provide one or more trading screens. A trading screen may provide one or more trading tools that allow interaction with one or more markets. For example, a trading tool may allow a user to obtain and view market data, set order entry parameters, submit order messages to an exchange, deploy trading algorithms, and/or monitor positions while implementing various trading strategies. The electronic trading tools provided by the trading application may always be available or may be available only in certain configurations or operating modes of the trading application.

A trading application may be implemented utilizing computer readable instructions that are stored in a computer readable medium and executable by a processor. A computer readable medium may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable storage media and to exclude propagating signals.

One or more components or modules of a trading application may be loaded into the computer readable medium of the trading device 110 from another computer readable medium. For example, the trading application (or updates to the trading application) may be stored by a manufacturer, developer, or publisher on one or more CDs or DVDs, which are then loaded onto the trading device 110 or to a server from which the trading device 110 retrieves the trading application. As another example, the trading device 110 may receive the trading application (or updates to the trading application) from a server, for example, via the Internet or an internal network. The trading device 110 may receive the trading application or updates when requested by the trading device 110 (for example, “pull distribution”) and/or un-requested by the trading device 110 (for example, “push distribution”).

The trading device 110 may be adapted to send order messages. For example, the order messages may be sent to through the gateway 120 to the exchange 130. As another example, the trading device 110 may be adapted to send order messages to a simulated exchange in a simulation environment which does not effectuate real-world trades.

The order messages may be sent at the request of a user. For example, a trader may utilize the trading device 110 to send an order message or manually input one or more parameters for a trade order (for example, an order price and/or quantity). As another example, an automated trading tool provided by a trading application may calculate one or more parameters for a trade order and automatically send the order message. In some instances, an automated trading tool may prepare the order message to be sent but not actually send it without confirmation from a user.

An order message may be sent in one or more data packets or through a shared memory system. For example, an order message may be sent from the trading device 110 to the exchange 130 through the gateway 120. The trading device 110 may communicate with the gateway 120 using a local area network, a wide area network, a wireless network, a virtual private network, a cellular network, a peer-to-peer network, a T1 line, a T3 line, an integrated services digital network (“ISDN”) line, a point-of-presence, the Internet, a shared memory system and/or a proprietary network such as TTNET™ provided by Trading Technologies, for example.

The gateway 120 may include one or more electronic computing platforms. For example, the gateway 120 may be implemented as one or more desktop computer, hand-held device, laptop, server, a portable computing device, a trading terminal, an embedded trading system, workstation with a single or multi-core processor, an algorithmic trading system such as a “black box” or “grey box” system, cluster of computers, or any combination thereof

The gateway 120 may facilitate communication. For example, the gateway 120 may perform protocol translation for data communicated between the trading device 110 and the exchange 130. The gateway 120 may process an order message received from the trading device 110 into a data format understood by the exchange 130, for example. Similarly, the gateway 120 may transform market data in an exchange-specific format received from the exchange 130 into a format understood by the trading device 110, for example.

The gateway 120 may include a trading application, similar to the trading applications discussed above, that facilitates or improves electronic trading. For example, the gateway 120 may include a trading application that tracks orders from the trading device 110 and updates the status of the order based on fill confirmations received from the exchange 130. As another example, the gateway 120 may include a trading application that coalesces market data from the exchange 130 and provides it to the trading device 110. In yet another example, the gateway 120 may include a trading application that provides risk processing, calculates implieds, handles order processing, handles market data processing, or a combination thereof.

In certain embodiments, the gateway 120 communicates with the exchange 130 using a local area network, a wide area network, a wireless network, a virtual private network, a cellular network, a peer-to-peer network, a T1 line, a T3 line, an ISDN line, a point-of-presence, the Internet, a shared memory system, and/or a proprietary network such as TTNET™ provided by Trading Technologies, for example.

The exchange 130 may be owned, operated, controlled, or used by an exchange entity. Example exchange entities include the CME Group, the London International Financial Futures and Options Exchange, the Intercontinental Exchange, and Eurex. The exchange 130 may include an electronic matching system, such as a computer, server, or other computing device, which is adapted to allow tradeable objects, for example, offered for trading by the exchange, to be bought and sold. The exchange 130 may include separate entities, some of which list and/or administer tradeable objects and others which receive and match orders, for example. The exchange 130 may include an electronic communication network (“ECN”), for example.

The exchange 130 may be an electronic exchange. The exchange 130 is adapted to receive order messages and match contra-side trade orders to buy and sell tradeable objects. Unmatched trade orders may be listed for trading by the exchange 130. Once an order to buy or sell a tradeable object is received and confirmed by the exchange, the order is considered to be a working order until it is filled or cancelled. If only a portion of the quantity of the order is matched, then the partially filled order remains a working order. The trade orders may include trade orders received from the trading device 110 or other devices in communication with the exchange 130, for example. For example, typically the exchange 130 will be in communication with a variety of other trading devices (which may be similar to trading device 110 which also provide trade orders to be matched.

The exchange 130 is adapted to provide market data. Market data may be provided in one or more messages or data packets or through a shared memory system. For example, the exchange 130 may publish a data feed to subscribing devices, such as the trading device 110 or gateway 120. The data feed may include market data.

The system 100 may include additional, different, or fewer components. For example, the system 100 may include multiple trading devices, gateways, and/or exchanges. In another example, the system 100 may include other communication devices, such as middleware, firewalls, hubs, switches, routers, servers, exchange-specific communication equipment, modems, security managers, and/or encryption/decryption devices.

### III. Expanded Example Electronic Trading System

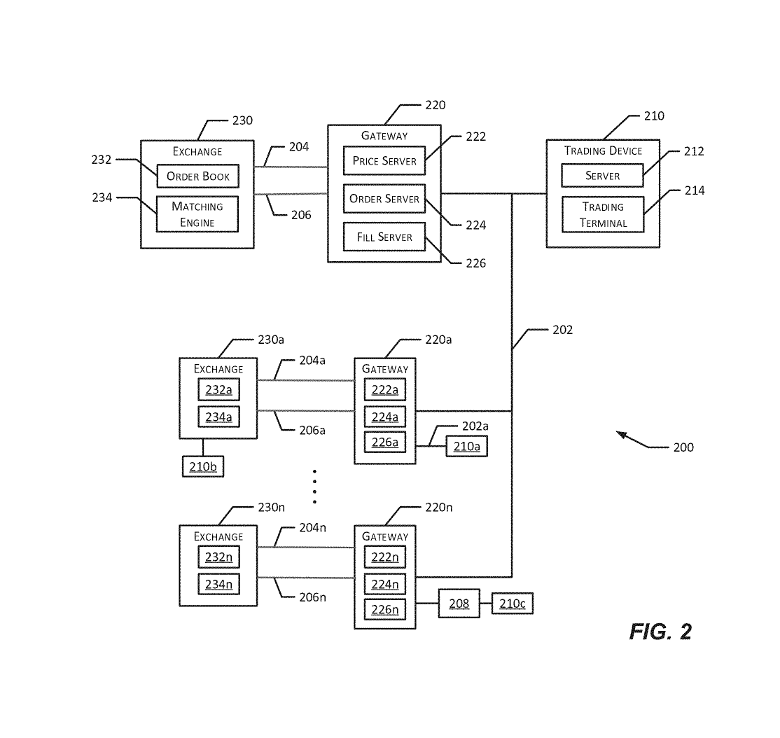

FIG. 2 illustrates a block diagram of another example electronic trading system 200 in which certain embodiments may be employed. In this example, a trading device 210 may utilize one or more communication networks to communicate with a gateway 220 and exchange 230. For example, the trading device 210 utilizes network 202 to communicate with the gateway 220, and the gateway 220, in turn, utilizes the networks 204 and 206 to communicate with the exchange 230. As used herein, a network facilitates or enables communication between computing devices such as the trading device 210, the gateway 220, and the exchange 230.

The following discussion generally focuses on the trading device 210, gateway 220, and the exchange 230. However, the trading device 210 may also be connected to and communicate with “n” additional gateways (individually identified as gateways 220a-220n, which may be similar to gateway 220 ) and “n” additional exchanges (individually identified as exchanges 230a-230n, which may be similar to exchange 230) by way of the network 202 (or other similar networks). Additional networks (individually identified as networks 204a-204n and 206a-206n, which may be similar to networks 204 and 206, respectively) may be utilized for communications between the additional gateways and exchanges. The communication between the trading device 210 and each of the additional exchanges 230a -230n need not be the same as the communication between the trading device 210 and exchange 230. Generally, each exchange has its own preferred techniques and/or formats for communicating with a trading device, a gateway, the user, or another exchange. It should be understood that there is not necessarily a one-to-one mapping between gateways 220a-220n and exchanges 230a-230n. For example, a particular gateway may be in communication with more than one exchange. As another example, more than one gateway may be in communication with the same exchange. Such an arrangement may, for example, allow one or more trading devices to trade at more than one exchange (and/or provide redundant connections to multiple exchanges).

Additional trading devices 210a-210n, which may be similar to trading device, 210, may be connected to one or more of the gateways 220a-220n and exchanges 230a-230n. For example, the trading device 210amay communicate with the exchange 230a via the gateway 220a and the networks 202a, 204a and 206a. In another example, the trading device 210b may be in direct communication with exchange 230a. In another example, trading device 210c may be in communication with the gateway 220n via an intermediate device 208 such as a proxy, remote host, or WAN router.

The trading device 210, which may be similar to the trading device 110 in FIG. 1, includes a server 212 in communication with a trading terminal 214. The server 212 may be located geographically closer to the gateway 220 than the trading terminal 214 in order to reduce latency. In operation, the trading terminal 214 may provide a trading screen to a user and communicate commands to the server 212 for further processing. For example, a trading algorithm may be deployed to the server 212 for execution based on market data. The server 212 may execute the trading algorithm without further input from the user. In another example, the server 212 may include a trading application providing automated trading tools and communicate back to the trading terminal 214. The trading device 210 may include additional, different, or fewer components.

In operation, the network 202 may be a multicast network configured to allow the trading device 210 to communicate with the gateway 220. Data on the network 202 may be logically separated by subject such as, for example, by prices, orders, or fills. As a result, the server 212 and trading terminal 214 can subscribe to and receive data such as, for example, data relating to prices, orders, or fills, depending on their individual needs.

The gateway 220, which may be similar to the gateway 120 of FIG. 1, may include a price server 222, order server 224, and fill server 226. The gateway 220 may include additional, different, or fewer components. The price server 222 may process price data. Price data includes data related to a market for one or more tradeable objects. The order server 224 processes order data. Order data is data related to a user's trade orders. For example, order data may include order messages, confirmation messages, or other types of messages. The fill server collects and provides fill data. Fill data includes data relating to one or more fills of trade orders. For example, the fill server 226 may provide a record of trade orders, which have been routed through the order server 224, that have and have not been filled. The servers 222, 224, and 226 may run on the same machine or separate machines. There may be more than one instance of the price server 222, the order server 224, and/or the fill server 226 for gateway 220. In certain embodiments, the additional gateways 220a-220n may each includes instances of the servers 222, 224, and 226 (individually identified as servers 222a-222n, 224a-224n, and 226a-226n).

The gateway 220 may communicate with the exchange 230 using one or more communication networks. For example, as shown in FIG. 2, there may be two communication networks connecting the gateway 220 and the exchange 230. The network 204 may be used to communicate market data to the price server 222. In some instances, the exchange 230 may include this data in a data feed that is published to subscribing devices. The network 206 may be used to communicate order data to the order server 224 and the fill server 226. The network 206 may also be used to communicate order data from the order server 224 to the exchange 230.

The exchange 230, which may be similar to the exchange 130 of FIG. 1, includes an order book 232 and a matching engine 234. The exchange 230 may include additional, different, or fewer components. The order book 232 is a database that includes data relating to unmatched trade orders that have been submitted to the exchange 230. For example, the order book 232 may include data relating to a market for a tradeable object, such as the inside market, market depth at various price levels, the last traded price, and the last traded quantity. The matching engine 234 may match contra-side bids and offers pending in the order book 232. For example, the matching engine 234 may execute one or more matching algorithms that match contra-side bids and offers. A sell order is contra-side to a buy order. Similarly, a buy order is contra-side to a sell order. A matching algorithm may match contra-side bids and offers at the same price, for example. In certain embodiments, the additional exchanges 230a-230n may each include order books and matching engines (individually identified as the order book 232a-232n and the matching engine 234a-234n, which may be similar to the order book 232 and the matching engine 234, respectively). Different exchanges may use different data structures and algorithms for tracking data related to orders and matching orders.

In operation, the exchange 230 may provide price data from the order book 232 to the price server 222 and order data and/or fill data from the matching engine 234 to the order server 224 and/or the fill server 226. Servers 222, 224, 226 may process and communicate this data to the trading device 210. The trading device 210, for example, using a trading application, may process this data. For example, the data may be displayed to a user. In another example, the data may be utilized in a trading algorithm to determine whether a trade order should be submitted to the exchange 230. The trading device 210 may prepare and send an order message to the exchange 230.

In certain embodiments, the gateway 220 is part of the trading device 210. For example, the components of the gateway 220 may be part of the same computing platform as the trading device 210. As another example, the functionality of the gateway 220 may be performed by components of the trading device 210. In certain embodiments, the gateway 220 is not present. Such an arrangement may occur when the trading device 210 does not need to utilize the gateway 220 to communicate with the exchange 230, such as if the trading device 210 has been adapted to communicate directly with the exchange 230.

### IV. Example Computing Device

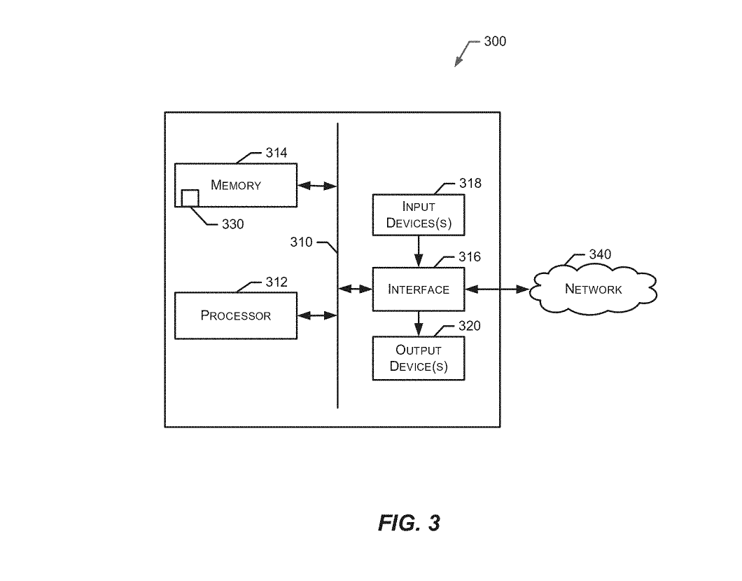

FIG. 3 illustrates a block diagram of an example computing device 300 which may be used to implement the disclosed embodiments. The trading device 110 of FIG. 1 may include one or more computing devices 300, for example. The gateway 120 of FIG. 1 may include one or more computing devices 300, for example. The exchange 130 of FIG. 1 may include one or more computing devices 300, for example.

The computing device 300 includes a communication network 310, a processor 312, a memory 314, an interface 316, an input device 318, and an output device 320. The computing device 300 may include additional, different, or fewer components. For example, multiple communication networks, multiple processors, multiple memory, multiple interfaces, multiple input devices, multiple output devices, or any combination thereof, may be provided. As another example, the computing device 300 may not include an input device 318 or output device 320.

As shown in FIG. 3, the computing device 300 may include a processor 312 coupled to a communication network 310. The communication network 310 may include a communication bus, channel, electrical or optical network, circuit, switch, fabric, or other mechanism for communicating data between components in the computing device 300. The communication network 310 may be communicatively coupled with and transfer data between any of the components of the computing device 300.

The processor 312 may be any suitable processor, processing unit, or microprocessor. The processor 312 may include one or more general processors, digital signal processors, application specific integrated circuits, field programmable gate arrays, analog circuits, digital circuits, programmed processors, and/or combinations thereof, for example. The processor 312 may be a single device or a combination of devices, such as one or more devices associated with a network or distributed processing. Any processing strategy may be used, such as multi-processing, multi-tasking, parallel processing, and/or remote processing. Processing may be local or remote and may be moved from one processor to another processor. In certain embodiments, the computing device 300 is a multi-processor system and, thus, may include one or more additional processors which are communicatively coupled to the communication network 310.

The processor 312 may be operable to execute logic and other computer readable instructions encoded in one or more tangible media, such as the memory 314. As used herein, logic encoded in one or more tangible media includes instructions which may be executable by the processor 312 or a different processor. The logic may be stored as part of software, hardware, integrated circuits, firmware, and/or micro-code, for example. The logic may be received from an external communication device via a communication network such as the network 340. The processor 312 may execute the logic to perform the functions, acts, or tasks illustrated in the figures or described herein.

The memory 314 may be one or more tangible media, such as computer readable storage media, for example. Computer readable storage media may include various types of volatile and non-volatile storage media, including, for example, random access memory, read-only memory, programmable read-only memory, electrically programmable read-only memory, electrically erasable read-only memory, flash memory, any combination thereof, or any other tangible data storage device. As used herein, the term non-transitory or tangible computer readable medium is expressly defined to include any type of computer readable medium and to exclude propagating signals. The memory 314 may include any desired type of mass storage device including hard disk drives, optical media, magnetic tape or disk, etc.

The memory 314 may include one or more memory devices. For example, the memory 314 may include local memory, a mass storage device, volatile memory, non-volatile memory, or a combination thereof. The memory 314 may be adjacent to, part of, programmed with, networked with, and/or remote from processor 312, so the data stored in the memory 314 may be retrieved and processed by the processor 312, for example. The memory 314 may store instructions which are executable by the processor 312. The instructions may be executed to perform one or more of the acts or functions described herein or shown in the figures.

The memory 314 may store a trading application 330. In certain embodiments, the trading application 330 may be accessed from or stored in different locations. The processor 312 may access the trading application 330 stored in the memory 314 and execute computer-readable instructions included in the trading application 330.

In certain embodiments, during an installation process, the trading application may be transferred from the input device 318 and/or the network 340 to the memory 314. When the computing device 300 is running or preparing to run the trading application 330, the processor 312 may retrieve the instructions from the memory 314 via the communication network 310.

### V. Strategy Trading

In addition to buying and/or selling a single tradeable object, a user may trade more than one tradeable object according to a trading strategy. One common trading strategy is a spread and trading according to a trading strategy may also be referred to as spread trading. Spread trading may attempt to capitalize on changes or movements in the relationships between the tradeable object in the trading strategy, for example.

An automated trading tool may be utilized to trade according to a trading strategy, for example. For example, the automated trading tool may include AUTOSPREADER®, provided by Trading Technologies.

A trading strategy defines a relationship between two or more tradeable objects to be traded. Each tradeable object being traded as part of a trading strategy may be referred to as a leg or outright market of the trading strategy.

When the trading strategy is to be bought, the definition for the trading strategy specifies which tradeable object corresponding to each leg should be bought or sold. Similarly, when the trading strategy is to be sold, the definition specifies which tradeable objects corresponding to each leg should be bought or sold. For example, a trading strategy may be defined such that buying the trading strategy involves buying one unit of a first tradeable object for Leg A and selling one unit of a second tradeable object for Leg B. Selling the trading strategy typically involves performing the opposite actions for each leg.

In addition, the definition for the trading strategy may specify a spread ratio associated with each leg of the trading strategy. The spread ratio may also be referred to as an order size for the leg. The spread ratio indicates the quantity of each leg in relation to the other legs. For example, a trading strategy may be defined such that buying the trading strategy involves buying 2 units of a first tradeable object for Leg A and selling 3 units of a second tradeable object for Leg B. The sign of the spread ratio may be used to indicate whether the leg is to be bought (the spread ratio is positive) or sold (the spread ratio is negative) when buying the trading strategy. In the example above, the spread ratio associated with Leg A would be “2” and the spread ratio associated with Leg B would be “−3.”

In some instances, the spread ratio may be implied or implicit. For example, the spread ratio for a leg of a trading strategy may not be explicitly specified, but rather implied or defaulted to be “1” or “−1.”

In addition, the spread ratio for each leg may be collectively referred to as the spread ratio or strategy ratio for the trading strategy. For example, if Leg A has a spread ratio of “2” and Leg B has a spread ratio of “−3”, the spread ratio (or strategy ratio) for the trading strategy may be expressed as “2:−3” or as “2:3” if the sign for Leg B is implicit or specified elsewhere in a trading strategy definition.

Additionally, the definition for the trading strategy may specify a multiplier associated with each leg of the trading strategy. The multiplier is used to adjust the price of the particular leg for determining the price of the spread. The multiplier for each leg may be the same as the spread ratio. For example, in the example above, the multiplier associated with Leg A may be “2” and the multiplier associated with Leg B may be “−3,” both of which match the corresponding spread ratio for each leg. Alternatively, the multiplier associated with one or more legs may be different than the corresponding spread ratios for those legs. For example, the values for the multipliers may be selected to convert the prices for the legs into a common currency.

The following discussion assumes that the spread ratio and multipliers for each leg are the same, unless otherwise indicated. In addition, the following discussion assumes that the signs for the spread ratio and the multipliers for a particular leg are the same and, if not, the sign for the multiplier is used to determine which side of the trading strategy a particular leg is on.

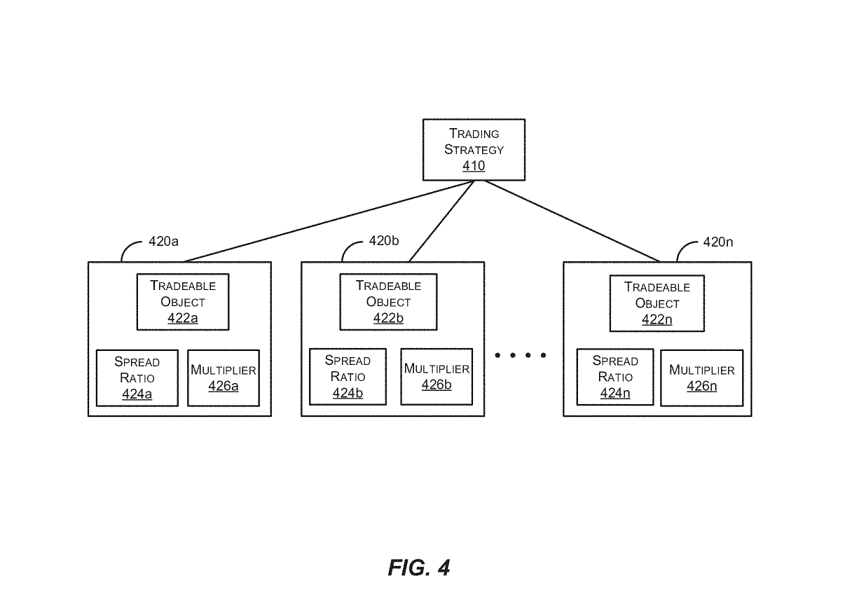

FIG. 4 illustrates a block diagram of a trading strategy 410 which may be employed with certain disclosed embodiments. The trading strategy 410 includes “n” legs 420 (individually identified as leg 420a to leg 420n). The trading strategy 410 defines the relationship between tradeable objects 422 (individually identified as tradeable object 422a to tradeable object 422n) of each of the legs 420a to 420n using the corresponding spread ratios 424a to 424n and multipliers 426a to 426n.

Once defined, the tradeable objects 422 in the trading strategy 410 may then be traded together according to the defined relationship. For example, assume that the trading strategy 410 is a spread with two legs, leg 420a and leg 420b. Leg 420a is for tradeable object 422a and leg 420b is for tradeable object 422b. In addition, assume that the spread ratio 424a and multiplier 426a associated with leg 420a are “1” and that the spread ratio 424b and multiplier 426b associated with leg 420b are “−1”. That is, the spread is defined such that when the spread is bought, 1 unit of tradeable object 422a is bought (positive spread ratio, same direction as the spread) and 1 unit of tradeable object 422b is sold (negative spread ratio, opposite direction of the spread). As mentioned above, typically in spread trading the opposite of the definition applies. That is, when the definition for the spread is such that when the spread is sold, 1 unit of tradeable object 422a is sold (positive spread ratio, same direction as the spread) and 1 unit of tradeable object 422b is bought (negative spread ratio, opposite direction of the spread).

The price for the trading strategy 410 is determined based on the definition. In particular, the price for the trading strategy 410 is typically the sum of price the legs 420a-420n comprising the tradeable objects 422a-422n multiplied by corresponding multipliers 426a-426n. The price for a trading strategy may be affected by price tick rounding and/or pay-up ticks. However, both of these implementation details are beyond the scope of this discussion and are well-known in the art.

Recall that, as discussed above, a real spread may be listed at an exchange, such as exchange 130 and/or 230, as a tradeable product. In contrast, a synthetic spread may not be listed as a product at an exchange, but rather the various legs of the spread are tradeable at one or more exchanges. For the purposes of the following example, the trading strategy 410 described is a synthetic trading strategy. However, similar techniques to those described below may also be applied by an exchange when a real trading strategy is traded.

Continuing the example from above, if it is expected or believed that tradeable object 422a typically has a price 10 greater than tradeable object 422b, then it may be advantageous to buy the spread whenever the difference in price between tradeable objects 422a and 422b is less than 10 and sell the spread whenever the difference is greater than 10. As an example, assume that tradeable object 422a is at a price of 45 and tradeable object 422b is at a price of 40. The current spread price may then be determined to be (1)(45)+(−1)(40)=5, which is less than the typical spread of 10. Thus, a user may buy 1 unit of the spread, which results in buying 1 unit of tradeable object 422a at a price of 45 and selling 1 unit of tradeable object 422b at 40. At some later time, the typical price difference may be restored and the price of tradeable object 422a is 42 and the price of tradeable object 422b is 32. At this point, the price of the spread is now 10. If the user sells 1 unit of the spread to close out the user's position (that is, sells 1 unit of tradeable object 422a and buys 1 unit of tradeable object 422b), the user has made a profit on the total transaction. In particular, while the user bought tradeable object 422a at a price of 45 and sold at 42, losing 3, the user sold tradeable object 422b at a price of 40 and bought at 32, for a profit of 8. Thus, the user made 5 on the buying and selling of the spread.

The above example assumes that there is sufficient liquidity and stability that the tradeable objects can be bought and sold at the market price at approximately the desired times. This allows the desired price for the spread to be achieved. However, more generally, a desired price at which to buy or sell a particular trading strategy is determined. Then, an automated trading tool, for example, attempts to achieve that desired price by buying and selling the legs at appropriate prices. For example, when a user instructs the trading tool to buy or sell the trading strategy 410 at a desired price, the automated trading tool may automatically place an order (also referred to as quoting an order) for one of the tradeable objects 422 of the trading strategy 410 to achieve the desired price for the trading strategy (also referred to as a desired strategy price, desired spread price, and/or a target price). The leg for which the order is placed is referred to as the quoting leg. The other leg is referred to as a lean leg and/or a hedge leg. The price that the quoting leg is quoted at is based on a target price that an order could be filled at in the lean leg. The target price in the hedge leg is also known as the leaned on price, lean price, and/or lean level. Typically, if there is sufficient quantity available, the target price may be the best bid price when selling and the best ask price when buying. The target price may be different than the best price available if there is not enough quantity available at that price or because it is an implied price, for example. As the leaned on price changes, the price for the order in the quoting leg may also change to maintain the desired strategy price.

The leaned on price may also be determined based on a lean multiplier and/or a lean base. A lean multiplier may specify a multiple of the order quantity for the hedge leg that should be available to lean on that price level. For example, if a quantity of 10 is needed in the hedge leg and the lean multiplier is 2, then the lean level may be determined to be the best price that has at least a quantity of 20 available. A lean base may specify an additional quantity above the needed quantity for the hedge leg that should be available to lean on that price level. For example, if a quantity of 10 is needed in the hedge leg and the lean base is 5, then the lean level may be determined to be the best price that has at least a quantity of 15 available. The lean multiplier and lean base may also be used in combination. For example, the lean base and lean multiplier may be utilized such that larger of the two is used or they may be used additively to determine the amount of quantity to be available.

When the quoting leg is filled, the automated trading tool may then submit an order in the hedge leg to complete the strategy. This order may be referred to as an offsetting or hedging order. The offsetting order may be placed at the leaned on price or based on the fill price for the quoting order, for example. If the offsetting order is not filled (or filled sufficiently to achieve the desired strategy price), then the strategy order is said to be “legged up” or “legged” because the desired strategy relationship has not been achieved according to the trading strategy definition.

In addition to having a single quoting leg, as discussed above, a trading strategy may be quoted in multiple (or even all) legs. In such situations, each quoted leg still leans on the other legs. When one of the quoted legs is filled, typically the orders in the other quoted legs are cancelled and then appropriate hedge orders are placed based on the lean prices that the now-filled quoting leg utilized.

### VI. Order Quantity Reallocation

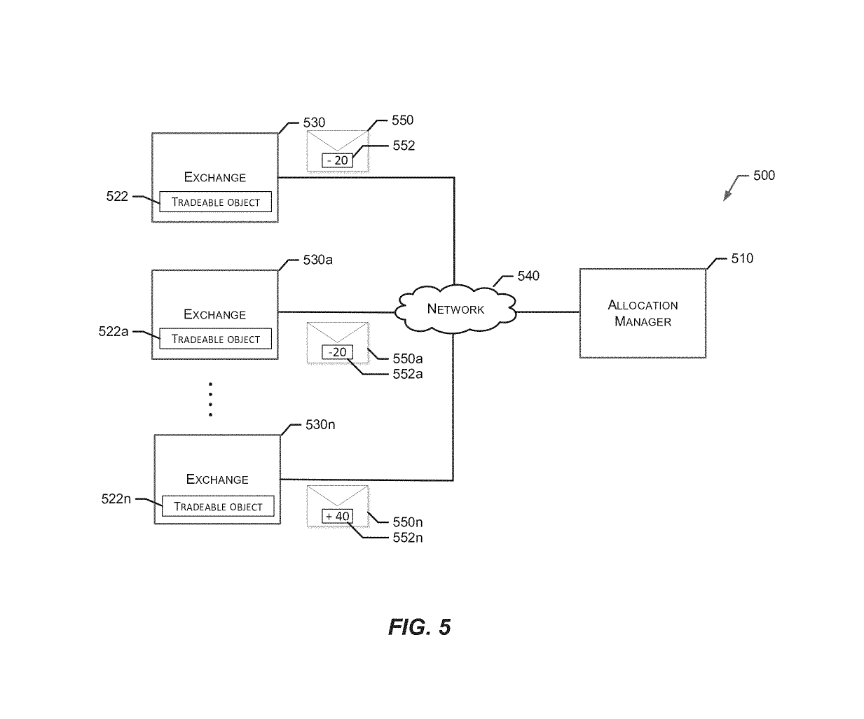

FIG. 5 illustrates an example trading system 500 that may be used to execute a trade. The system 500 may include an allocation manager 510, exchanges 530 to 530n, and a communication network 540. The allocation manager 510 may be implemented at a trading device, an exchange, and/or another computing device. The allocation manager 510 may be distributed across one or more trading devices, exchanges, and/or other computing devices. The exchanges 530 to 530n may facilitate trades related to tradeable objects, such as tradeable object 522 to 522n for example. The allocation manager 510 and the exchanges 530 to 530n may communicate over the communication network 540 to facilitate trades related to the tradeable objects 522 to 522n. The tradeable objects 522 to 522n may be the same tradeable objects at different exchanges or different tradeable objects that are otherwise fungible with the tradeable objects at the other exchanges. As used herein, tradeable objects are considered to be fungible if they have the same ticker symbol, contract type, product type, order price, order type (e.g., bid or offer), or if they have a defined relationship established therebetween. Two or more tradeable object may be of different contract types, product types, and/or durations and may utilize a ratio, and/or multiplier to establish a defined relationship between the objects. For example, three contracts relating to different tradeable objects may have a mathematical relationship defined between each pair of the three tradeable objects.

The allocation manager 510 may receive order messages from trading devices. The order messages may include trade orders related to the tradeable object 522. The trade orders may be part of a trading strategy having multiple legs. For example, the trading strategy may be defined using a synthetic spread for trading across multiple exchanges. The allocation manager 510 may split the received trade orders between two or more of the exchanges 530 to 530n. The allocation manager 510 may split the orders in an attempt to have the orders filled more quickly and/or take advantage of available prices for filling the order at different exchanges. The allocation manager 510 may split the orders according to a fixed percentage (e.g., defined by a user), in a manner proportional to quantities available at different exchanges, based on a ranking of the contracts, for example.

The allocation manager 510 may determine that tradable object 522 is fungible with tradable objects 522a, 522n at exchanges 530a, 530n, respectively. The allocation manager 510 may send an order message 550 to the exchange 530, an order message 550a to the exchange 530a, and an order message 550n to the exchange 530n. The order messages 550, 550a, and 550n, may include trade orders related to the tradable objects 522, 522a, and 522n, respectively. The order messages 550, 550a, and 550n may specify one or more order parameters, such as an order quantity and/or an order price, for example.

The trade orders 550, 550a, and 550n may be placed in order queues at each of the respective exchanges 530, 530a, and 530n. The exchanges 530, 530a, and 530n may match orders in the order queues based on first-in-first-out (FIFO), pro-rata, or last-in-first-out (LIFO) matching. The exchanges 530, 530a, 530n may match orders at different rates, such that the quantity of the trade orders at exchange 530n may be matched prior to the quantity of the trade orders at exchange 530 or exchange 530a, The trade orders may be matched faster at the exchange 530n due to the contra-side trade orders to buy or sell the tradeable objects 522 being available earlier and/or the trade execution rate being faster at the exchange 530n.

The allocation manager 510 may receive market data from the exchanges 530, 530a. and 530n that indicates the order quantity available at an order queue at each exchange. Based on the market data, the allocation manager 510 may determine to change, update and/or reallocate the order quantity at one or more exchanges. For example, if the exchange 530n is matching orders related to the tradeable object 522n at a faster rate than the exchange 530 or the exchange 530a are matching orders related to the tradeable objects 522 and 522a, respectively, the allocation manager 510 may reallocate portions of the order quantity from the exchange 530 and/or the exchange 530a to the exchange 530n. The market data received from each exchange may be based on a market update message or an order update message. As the market update messages or the order update messages may be received from the exchanges 530, 530a, and 530n at different times, the reallocation may be delayed until the market update messages or the order update messages are received from each of the exchanges 530, 530a, and 530n. In another example, the reallocation may delayed for a period of time (e.g., 10 milliseconds) from the receipt of the first the market update messages or the order update messages in the group of messages expected from the exchanges 530, 530a, and 530n over a period of time.

The market data received at the allocation manager 510 may indicate a position-in-queue value for the trade orders at each exchange. The position-in-queue value indicates a position of an order quantity in the order queue at an exchange (e.g., including the total quantity of units to fill the order). More specifically, the position-in-queue value indicates the position in the order queue for the last tradeable object in a working order quantity for a working order to be fully matched at an exchange. For example, if a trade order at an exchange includes twenty units and trade order is next in the queue for being matched, the position-in-queue value for the trade order may be twenty. When the trade order has five units ahead of the order in the order queue, the position-in-queue value for the trade order may be twenty-five. The allocation manager 510 may determine that the exchange 530n is matching orders faster than the exchange 530 and/or the exchange 530a by comparing the position-in-queue values of the trade orders at the exchanges. The allocation manager 510 may redistribute the order quantity allocated to exchanges based on the position-in-queue values and/or the quantity values at each exchange. The allocation manager 510 may transfer units in the order queue from one or more exchanges to another exchange based on this determination.

As shown in FIG. 5, the allocation manager 510 may generate and send order messages 550, 550a, and 550n to exchanges 530, 530a, and 530n, respectively, to reallocate the quantity of units in the order queue at each exchange. If the exchange 530n is matching trade orders related to the tradeable object 522n at a faster rate than the exchange 530 and the exchange 530a are matching trade orders related to the tradeable objects 522 and 522a, respectively, the allocation manager 510 may reallocate portions of the order quantity at the exchange 530 and the exchange 530a to the exchange 530n.

The allocation manager 510 may reallocate order quantities between exchanges via quantity allocation amount parameters. The order messages 550, 550a, and 550n may include quantity allocation amount parameters 552, 552a, and 552n, respectively, for reallocating order quantities amongst the exchanges. The quantity allocation amount parameter 552 may indicate an amount to adjust the quantity of the tradeable object 522 that is pending at the exchange 530. For example, the quantity allocation amount parameter 552 may reduce an existing number of units allocated to the exchange 530 by twenty. Where the initial trade order submitted to the exchange 520 was a buy order, the quantity allocation amount parameter 552 may be a quantity of the tradeable object 522 to sell at the exchange 530. The quantity allocation amount parameter 552 may be included in the order message 550 with the corresponding price of the buy order that is currently in the order queue at the exchange 530. Where the initial trade order submitted to the exchange 520 was a sell order, the quantity allocation amount parameter 552 may be a quantity of the tradeable object 522 to buy at the exchange 530. The quantity allocation amount parameter 552 may be included in the order message 550 with the corresponding price of the sell order that is currently in the order queue at the exchange 530. The order quantity indicated in the quantity allocation amount parameter 552 being matched may cause a change in the position-in-queue value that is currently pending at the exchange 530. For example, the quantity allocation amount parameter 552 being matched at the exchange 530 may cause the position-in-queue value for the pending orders at the exchange 530 to be reduced by the same amount due to the preceding orders in the queue being matched. The quantity allocation amount parameter 552a may similarly indicate an amount to adjust the quantity the tradeable object 552a that is pending at the exchange 530a. Though FIG. 5 identifies the quantity allocation amount parameters 522 and 552a being the same, the quantity identified by the quantity allocation amount parameters 522 and 552a may be different.

The quantity allocation amount parameter 552n indicates an amount to adjust the quantity of a pending order for a tradeable object 522n traded at the exchange 530n. The quantity allocation amount parameter 552n may increase the quantity of a pending order for the tradeable object 522n by an aggregate amount that is being removed (e.g., forty units) from the order queues at the other exchanges. The order including the quantity indicated in the quantity allocation amount parameter 552n may be submitted to the exchange 530n and placed in the order queue as a new order. The trade order 550n may be a contra-side order of the trade orders 550 and 550a (e.g., the amount that is being sold on the exchange 530 and the exchange 530a may be bought on the exchange 530n).

The quantity allocation amount parameters 552, 552a, 552n may be calculated at the allocation manager 510 and/or sent to the exchanges upon the occurrence of a triggering criteria. In an example, the quantity allocation amount parameters 552, 552a, 552n may be calculated when the position-in-queue value for a working order at the exchange 530n reaches a threshold value (e.g., a position-in-queue value equal to the order quantity of the working order indicating that the working order at the exchange 530n is waiting to be matched) and/or the contra-side position-in-queue value is at a threshold value (e.g., a value of zero indicating that the working order at the exchange 530n is waiting to be matched). The quantity allocation amount parameters 552, 552a, 552n may be calculated and/or sent when a tracked or monitored position-in-queue value for the working order at the exchange 530n reaches a predefined value or a percentage of the position-in-queue values pending at one or more other exchanges. The quantity allocation amount parameters 552, 552a, 552n may be calculated and/or sent when it is determined that the quantity resting in the order queue at the exchange 530n reaches a threshold value (e.g., zero or another predefined amount) and/or is ahead of the position of the other trade orders in the order queue of the other exchanges by a predefined value. The quantity allocation amount parameters 552, 552a, 552n may be calculated at the allocation manager 510 and/or sent to the exchanges when a certain price level or quantity is reached at an exchange.

Though FIG. 5 shows the reallocation being performed amongst three different exchanges, the reallocation may be performed using any two or more exchanges. The reallocation may be based on the number of legs defined in the trading strategy. Each exchange may include one or more legs defined in the trading strategy. The allocation manager 510 may receive a definition for a trading strategy that may identify the legs at which the trade may be executed. For example, the definition may specify that an order quantity be allocated to two different legs at exchange 530.

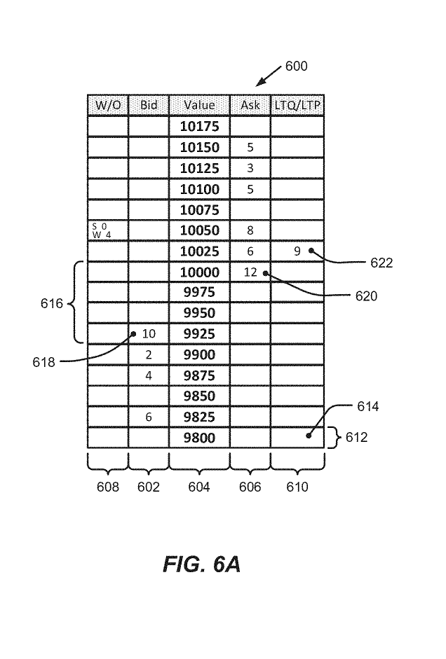

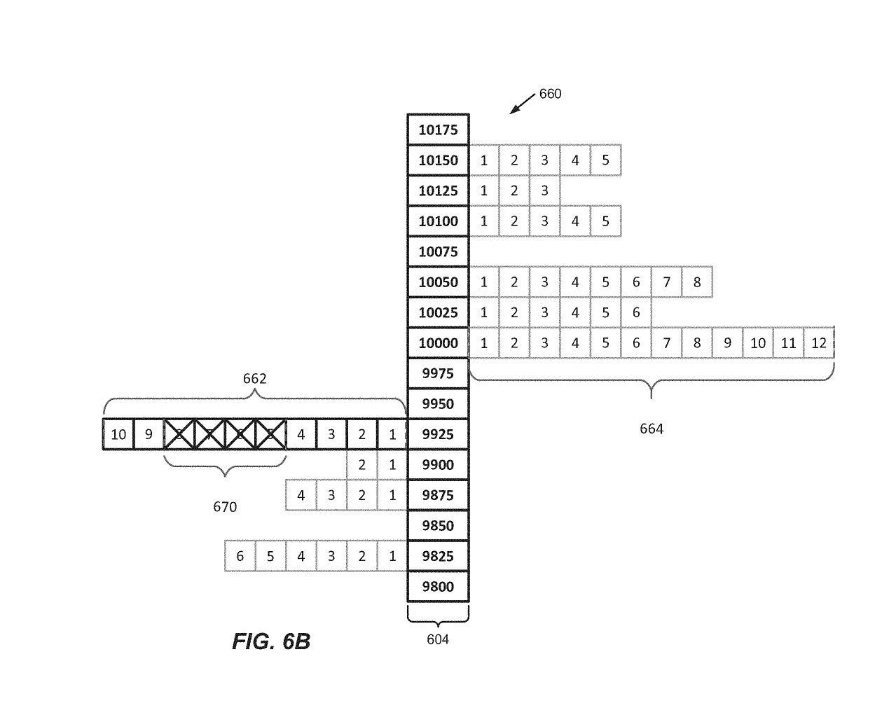

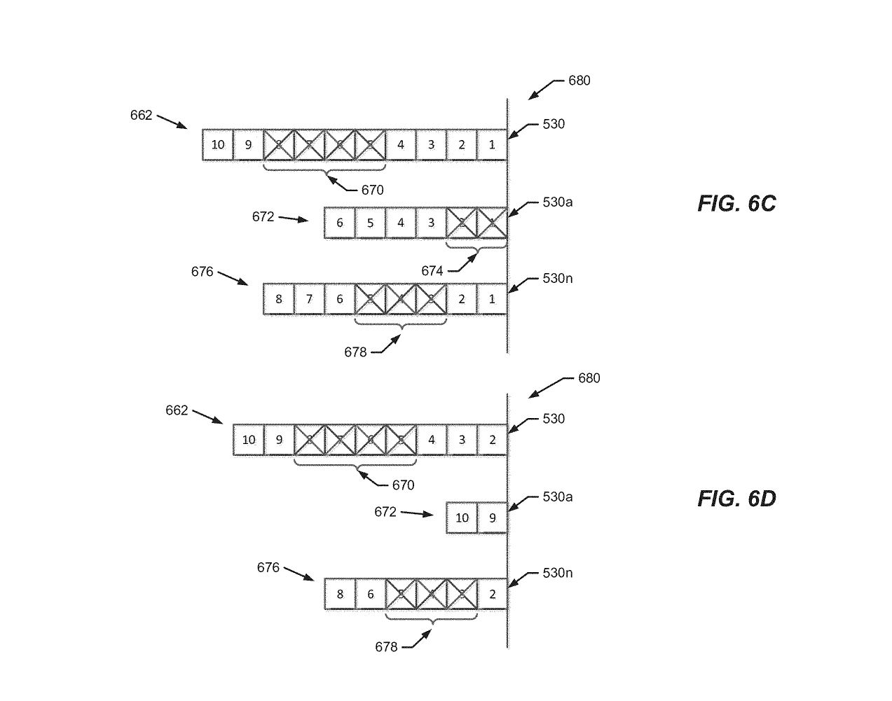

FIG. 6A illustrates an example trading interface 600 in which certain embodiments may be employed. The example trading interface 600 shows market data for a tradeable object at a first point in time. While the following examples are described in conjunction with the example electronic trading system 200 of FIG. 2, the examples disclosed herein may be implemented in other electronic trading systems, such as the example trading system 100 of FIG. 1.

As described above in conjunction with FIG. 2, the trading device receives market data related to one or more tradeable objects from the exchange 230 and/or the exchanges 230a-230n through the gateway 220 and/or the gateways 220a-220n, respectively. The trading device 210 provides a trading application including trading tools to process and/or organize the market data and provide the example trading interface 600. Trading tools include, for example, MD TRADER®, X_TRADER®, ADL®, AUTOSPREADER®, and AUTOTRADER™, each provided by Trading Technologies. The trading device 210 provides the trading interface 600 to enable a user to view market data and communicate trade orders and trade actions with an electronic exchange.

In the illustrated example of FIG. 6A, the trading interface 600 includes a bid column 602, a value column 604, and an ask column 606. The trading interface 600 further includes a working order (W/O) column 608 and a last traded quantity (LTQ)/last traded price (LTP) column 610. The trading interface 600 may include other columns such as an estimated position in queue (EPIQ) column, a single combined bid/ask column, a user-defined indicator column, an inside market indicator column, and/or any other column for providing indicators. The trading interface 600 also includes rows such as row 612. The columns intersect with the rows to define cells such as cell 614. In other embodiments, different orientations other than vertical columns may be used (e.g., horizontal and diagonal arrangements).

In the illustrated example, bid indicators representing the bid quantities of the tradeable object are displayed in the bid column 602, value indicators corresponding to value levels are displayed in the value column 604, and ask indicators representing the ask quantities of the tradeable object are displayed in the ask column 606. A bid quantity is a quantity available on the bid side of the tradeable object at a given value level. The value levels can be configured to represent prices, net change, derivatives of price, consolidated prices, synthetic tradeable object pricing, spread pricing, and/or other representations of value. The ask quantity is a quantity available on the ask side of the tradeable object at a given value level. The indicators are not limited to numerical values and can include any type or combination of indicator or symbol to illustrate the presence of available quantity without providing a specific numeric value. For example, the indicators may include text, icons, colors, lines, and/or other graphical representations. In one example, the indicators may represent a range of quantity available at particular value levels in place of specific, and frequently changing, quantity values. In another example, the relative size of indicators may proportionally represent the quantity available. In another example, the indicators may represent simply that there is quantity available with no illustration of the amount in excess of zero.

Trading interfaces, such as the trading interface 600, may include indicators to identify the inside market. The inside market indicators may utilize multiple representations to identify the highest bid price and the lowest ask price. The inside markets indicators may also include additional information such as information related to quantities at the inside market. Examples of inside market indicators include a best bid price indicator representing the highest available bid price, a best ask price indicator representing the lowest available ask price, and/or an indicator representing a range between the highest available bid price and the lowest available ask price. As shown in FIG. 6A, the inside market indicator may highlight and identify the range 616 of value levels between the highest available bid price of “9975” and the lowest available ask price of “10000”. Inside market indicators may be displayed within the trading interface to identify specific value level(s) in the value column 604. For example, a best bid price indicator may be displayed in a cell containing a bid quantity indicator and corresponding to a value level that reflects the best bid price. As another example, a best ask price indicator may be a color or symbol combined with an ask quantity indicator in the ask column 606 in a cell corresponding to a value level that reflects the best ask price. As another example, inside market indicators may be displayed at value levels within the value column 604 that reflect the best bid price and the best ask price. The inside market indicators can include any type or combination of indicator or symbol (e.g., the indicators may include text, icons, colors, lines, and/or other graphical representations).

In certain embodiments, the inside market indicators may be provided by the presence of a quantity indicator. The presence of a quantity indicator refers to the existence and location of the quantity indicator. For example, the presence of the best bid quantity indicator, independent of the quantity value displayed at any given point in time, in the bid column may be the best bid price indicator. Thus, the existence of a quantity indicator at the highest value level in the bid column is the best bid price indicator. To be clear, in this example, the value of the bid quantity indicator is not part of the best bid price indicator. Rather, the existence of the bid quantity indicator itself at the highest value level in the bid column is the best bid price indicator. In other words, the display of the highest bid quantity indicator is the best bid price indicator. As shown in FIG. 6A, the presence of the bid quantity indicator “10” at the highest value level in the bid column at the price of “9975” is the best bid price indicator 618. Similarly, the presence of the ask quantity indicator “12” at the lowest value level in the ask column at the price of “10000” is the best ask price indicator 620.

From the user's perspective, the trading interface 600 may present and display indicators, such as inside market and LTP/LTQ indicators, in a manner that conveys the appearance of movement relative to the value column 604. For example, the manner in which the trading interface alters the position of the best bid price indicator and the best ask price indicator relative to the value levels within the value column may allow the user to perceive changes in both the speed and direction of trading within a market. The trading interface 600 updates based on received market data. For example, the trading interface 600 moves the best bid price indicator 618 relative to the value column 604 when the received market data includes a quantity at a new highest bid price. As another example, the trading interface 600 moves a LTP indicator 622 (shown in the LTQ column 610 of FIG. 6A) relative to the value column 604 when the received market data includes a new last traded price.

The trading interface 600 shown in FIG. 6A depicts and identifies the inside market via the best bid price indicator 618 aligned with the highest available bid price and the best ask price indicator 620 aligned with the lowest available ask price at a first point in time. For example, the best bid price indicator 618 may be moved to reflect the change in the best bid price from “9900” to “9925” (shown in FIG. 6A). Similarly, the best ask price indicator 620 may be moved to reflect the change in the best ask price from “10075” to “10000” (shown FIG. 6A). By observing the movement of the inside market indicators relative to the value column 604 in the described manner, the user can quickly perceive that the market is tightening as difference between the best bid and best ask decreases.

The quantity indicators displayed as part of the trading interface 600 each represent an order queue associated with the corresponding price displayed at each value level and arranged to form the value column 604. For example, the bid quantity indicator “10” adjacent to the price of “9925” displayed in the value column 604 represents an order queue waiting to buy ten (10) individual tradeable objects at the corresponding price. Similarly, the ask quantity indicator “12” adjacent to the price of “10000” displayed in the value column 604 represents an order queue waiting to sell twelve (12) individual tradeable objects at the corresponding price.

FIG. 6B illustrates an alternate interface 660 representing the trading interface 600 in which the order queue associated with each value level in the value column 604 is expanded to provide detailed quantity and queue position information. For example, an order queue 662 corresponding to the price of 9925 includes ten (10) bids to buy tradeable objects at the indicated price. Similarly, an order queue 664 corresponding to the price of 10000 includes twelve (12) bids to sell tradeable objects at the indicated price. As illustrated in FIG. 6B, each tradeable object in the order queue 662 is numbered 1 to 10 to indicate a position within the queue. In the illustrated example, lower numbered tradeable objects are closer (i.e., will be filled sooner) to being filled than higher numbered tradeable objects.

The order queue 662 further includes an order 670 to buy four (4) tradeable objects at a price of 9925. The order 670 depicted in FIG. 6B is resting in the order queue 662 and has a queue position of eight. In other words, in order to completely fill the order 670, eight tradeable objects must be available for purchase (i.e., contra to the individual orders in the queue). If, for example, six tradeable objects were available for sale at a price of 9925, then the orders identified as 1 to 6 in the order queue 662 would be filled and removed from the queue leaving only orders 7 to 10 remaining. The remaining four orders (orders 7 to 10) includes two (2) orders (i.e., the order for a tradeable object identified as 7 and the order for a tradeable object identified as 8) from order 670 and two unrelated orders 9-10. In this example, the orders originally identified as 7 and 8 are next to be filled when contra-side orders at 9925 are available.

The order queue 662 depicted in FIG. 6B is a buy-side order queue associated with the price of 9925, however it should be noted that a similar order queue exists for both the buy-side and sell-side of each value level in the value column 604.

Table 1 illustrates an example trading strategy including three components identified as individually as Leg A, Leg B and Leg C. Each of the components can, for example, be traded on markets offered at different exchanges (e.g., exchange 530, exchange 530a and exchange 530n). In the illustrated example, each of the three components are assumed to fungible with the remaining components meaning that the components can be traded on any of the three exchanges 530, 530a, and 530 n.

TABLE 1

| Component | Working | Total | Position-In-Queue (PIQ) |
|---|---|---|---|
| Leg A (Exchange 530) | 4 | 10 | 8 |
| Leg B (Exchange 530a) | 2 | 6 | 2 |
| Leg C (Exchange 530n) | 3 | 8 | 5 |

Table 1 depicts the relevant market data related to each of the three components included in the example trading strategy and individually identified as Leg A, Leg B and Leg C. For example, the first row of the displayed market data indicates that Leg A has a quantity of four tradeable objects, out of ten total available for this leg, working at the eighth position-in-queue at the exchange 530. The position in queue for Leg A is the total of number of working items in the order (four) plus the number of items ahead in the queue (four). Similarly, the second row of the displayed market data indicates that Leg B has a quantity of two tradeable objects, out of six total available for this leg, working at the second position-in-queue at the exchange 530a. The position in queue for Leg B indicates that this leg is next to be filled by any contra-side orders. The third row of the displayed market data indicates that Leg C has a quantity of three tradeable objects, out of eight total available for this leg, working at the fifth position-in-queue at the exchange 530n. The position in queue for Leg B indicates that two units must be filled before the units associated with this leg are eligible to be filled.

FIG. 6C illustrates a graphical representation of the market data relating to Leg A, Leg B, and Leg C as described in Table 1. In particular, FIG. 6C illustrates a total quantity of ten units in order queue 662 including order 670 defined as a part of Leg A in the eighth position; a total of six units in order queue 672 including order 674 defined as a part of Leg B in the second position; and a total of eight units in order queue 676 including order 678 defined as a part of Leg C in the fifth position. Each of the order queues 662, 672, and 676 is aligned along line 680 representing the next orders to be filled upon receipt of a contra-side order.

An allocation manager, such as allocation manager 510 for example, may receive market data and market data updates and determine whether to redistribute an order quantity for working orders across the different working legs of the trading strategy. The allocation manager may identify triggering criteria in the market data. For example, given that order 674 is next in lines to be filled in Leg B, the allocation manager may decide to forgo redistributing quantity from one of the remaining orders 670 and 678 to maintain the queue position and increase the likelihood of a fill in Leg B. In certain embodiments, the allocation manager may determine that the volume of trading detected at order queue 662 may warrant redistributing volume (i.e. units in order 678) to order 670.

In certain embodiments, the trigger criteria may be satisfied but the allocation manager may prevent redistribution based on a trading rule. An example trading rule may include a prohibition against cross-trading (i.e., buy and selling the same tradeable object). In certain embodiments, the trading rules may be based on transaction fees or costs, trade or order modification frequency, a determination of order types between the fungible legs.

TABLE 2

| Component | Working | Total | Position-In-Queue (PIQ) |
|---|---|---|---|
| Leg A (Exchange 530) | 4 | 9 | 7 |
| Leg B (Exchange 530a) | 0 | 2 | 0 |
| Leg C (Exchange 530n) | 3 | 6 | 4 |

Table 2 depicts the updated relevant market data related to each of the components individually identified as Leg A, Leg B and Leg C listed in Table 1. For example, the first row of the displayed market data indicates that Leg A has a quantity of four tradeable objects, out of nine total available for this leg, working at the seventh position-in-queue at the exchange 530. This may indicate that the trading volume at exchange 530 for Leg A is low with respect to the remaining components of the trading strategy. Similarly, the second row of the displayed market data indicates that Leg B has a no quantity working and two total remaining and available of the tradeable objects for this leg. The change in available tradeable objects may indicate that the trading volume at exchange 530a for Leg B is high with respect to the remaining components of the trading strategy. The third row of the displayed market data indicates that Leg C continues to have a quantity of three tradeable objects working at the fourth position-in-queue at the exchange 530n.

FIG. 6D illustrates a graphical representation of the market data relating to Leg A, Leg B, and Leg C as described in Table 2. In particular, FIG. 6D illustrates a total quantity of nine units in order queue 662 including order 670 defined as a part of Leg A in the seventh position. In the duration between the market data of Table 1 and Table 2, the unit identified as 1 has been filled at the exchange 530. FIG. 6D further illustrates that a total of two units in order queue 672. In the illustrated example, the six original quantity from order queue 672 have been filled, two additional units associated with Leg B have been filled and two new units have been added to the queue 672 are identified as units 9 and 10. FIG. 6D also illustrates that a total of six units in remain in order queue 676 including order 678 defined as a part of Leg C in the fourth position.

The allocation manager may redistribute the trade orders to lower the highest total position-in-queue value and/or the greatest working order value. The allocation manager may redistribute the working bids from Leg A, because Leg A has the greatest position-in-queue and/or the greatest working total. The allocation manager may redistribute the working bids from Leg A to Leg B in an attempt to capitalize on the fast moving queue 672. The allocation manager may redistribute the entire working order, or a portion thereof.

The allocation manager may consider other available order quantities in an order queue that may not be a part of the working orders in an identified trading strategy when determining whether to reallocate an order quantity. For example, the highest total position-in-queue value and/or the greatest working order value may not be reduced, or may not be reduced by a predefined amount, by performing a reallocation of an order quantity due to other orders in an order queue having priority for being matched, so the allocation manager may decide not to reallocate.

When the allocation manager decides to redistribute the working orders from one leg to another based on the greatest position-in-queue value, the greatest position-in-queue value across the legs may be reduced. For example, if the redistribution of the working order would not result in a lower position-in-queue value, or the position-in-queue value would not be reduced by a predefined amount, the allocation manager may prevent redistribution.

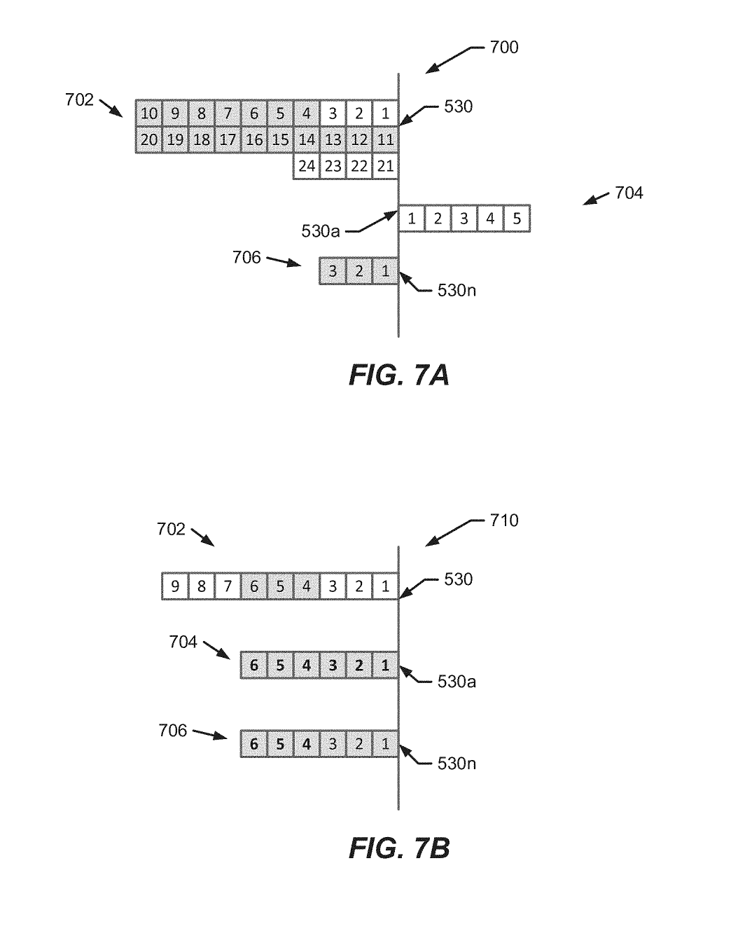

FIGS. 7A and 7B illustrate graphical representations of the market data relating to Leg A, Leg B, and Leg C of an example trading strategy. The represented market data 700, 710 describe different orders for fungible tradeable objects at exchanges 530, 530a, and 530n at different points in time. In certain embodiments, market data may represent an initial distribution of a quantity of fungible tradeable objects across multiple exchanges according to a trading strategy. For example, Leg A may reflect an initial distribution of working orders at exchange 530, Leg B may reflect an initial distribution of working orders at exchange 530a, and Leg C may reflect an initial distribution of working orders at exchange 530n once a trading strategy order is submitted. In certain embodiments, the market data 700 may represent orders for a quantity of fungible tradeable objects(s) distributed across exchanges 530, 530a, and 530n according to a trading strategy. For example, Leg A may reflect the working orders at exchange 530, Leg B may reflect the working orders at exchange 530a, and Leg C may reflect the working orders at exchange 530n after an order has been working in the markets for a period of time.

The allocation manager, such as allocation manager 510 for example, may receive an order related to a tradable object. The order may include an order quantity. The allocation manager may distribute the order as working bids and/or working orders between the different legs in accordance with a definition of a trading strategy. As shown in graphical representation of market data 700, after a certain period of time Leg A might consist of an order quantity of seventeen (17) units working at the twentieth (20) position-in-queue (PIQ) of exchange 530; the order queue 704 associated with Leg B at exchange 530a indicates six (6) units contra-side to the tradable object defined in according with the trading strategy are available; and Leg C might consist of an order quantity of three (3) united working at the third (3) PIQ in order queue 706 of exchange 530n. Each of the legs of the trading strategy are assumed to include the same tradeable object, or a tradeable object that is otherwise fungible. The order queues 702, 704 and 706 may be assumed to operate according to first-in, first-out (FIFO) principles.

The allocation manager may decide to reallocate the working orders based on a triggering criteria. The triggering criteria may be, for example, a determination that the position-in-queue value for one of the legs indicates the leg is next in line to be filled; a determination that it is possible to cross the market in at least one leg; a determination that the position-in-queue values for one of the legs is predefined value (e.g., a position-in-queue values of one indicates that the next contra-side order will be matched; or a position-in-queue value that represents a percentage of the total queue size).

In response to the received updated market data 710, or other determined triggering criteria the allocation manager may initiate a process to reallocate a quantity of the working or otherwise available tradeable objects across the fungible legs of the trading strategy. In on embodiment, the allocation manager may allocate the tradeable objects with the intent to achieve the lowest combined position-in-queue value across the legs of the trading strategy. In certain configurations, the allocation manager may prevent reallocation at a leg if there is not an available contra-side order quantity available on a given leg, a contra-side order quantity that meets the order quantity being reallocated, or a contra-side order quantity that is a predefined amount greater than the order quantity being reallocated. The allocation manager may also prevent reallocation if a determined minimum position-in-queue value or a quantity allocation amount is less than a predetermined threshold.

Market data depicted in FIG. 7B, reflects changes in the market data 700 after a fixed period of time. The changed or updated market data 710 reflects new market data for working bids, working offers, and associated position-in-queue values. In particular, FIG. 7B shows an example of market data an instant in time after a reallocation of the working orders displayed in the market data 700 shown in FIG. 7A. The allocation manager may receive updated market data that identify or contain specific market data updates for individual legs of the trading strategy. As shown in FIG. 7B, the allocation manager may reallocate the working quantity for Leg A across the remaining legs in an attempt to optimize the position-in-queue values. The allocation manager may decide that the position-in-queue values across the legs are not aligned, or that one or more of the legs are not within a predefined position-in-queue value of one another, and may optimize the position-in-queue values across the legs by re-aligning position-in-queue values or bringing the position-in-queue values within a predefined range of one another.

The allocation manager may calculate a minimum position-in-queue value across the legs based on the position-in-queue value for each of the legs and the available contra-side order quantities (e.g., the working order quantities for the identified trading strategy and/or the other available order quantities) on each of the legs. Equation 1 illustrates an example equation that may be used determining a minimum position-in-queue value across the legs of the trading strategy.

MinPIQ=(Sum(Legs PIQ)−Sum(Available Order Quantity))/NumLegs Equation 1

In Equation 1, the target minimum position-in-queue value may be determined by subtracting the sum of the available order quantities having the same order type (e.g., bid or offer) across the legs from the sum of the position-in-queue values for the available contra-side orders and dividing the result by the number of legs in the trading strategy. Applying Equation 1 to the market data 700 in FIG. 7A, the minimum position-in-queue value may be determined by subtracting the sum of the available working offers across the legs (e.g., 0+5+0) from the sum of the position-in-queue values 708 a for the working bids 704 a across the legs 702 (e.g., 20+0+3) and dividing by the number of legs in the trading strategy (e.g., three). The resulting minimum position-in-queue value when applying Equation 1 to the market data 700a is 6. In certain embodiment, the minimum PIQ equation may be configured to round up, or round down to the nearest integer.

The allocation manager may perform reallocation of the working quantity of Leg A as described in the market data 700 (see FIG. 7A) to obtain the minimum position-in-queue value for the working orders associated with each of the legs. For example, the allocation manager may redistribute a quantity of eleven (11) tradeable objects from order queue 702 associated with Leg A (see FIG. 7A) to order queue 704 associated with Leg B. In particular, five (5) of the redistributed tradeable objects would immediately cross the market to be matched and filled by the five (5) contra-side orders shown in FIG. 7A. The remaining six (6) of the redistributed tradeable objects are subsequently held in the order queue 704 waiting to be match against additional contra-side orders. The resulting minimum position-in-queue of the order queue 704 is six (6) once the redistribution is complete. Moreover, the allocation manager may redistribute a quantity of three (3) tradeable objects from order queue 702 associated with Leg A (see FIG. 7A) to order queue 706 associated with Leg C. In this way, the order queue 706 is increased from three (3) to six (6) to achieve the desired minimum position-in-queue value determined according to Equation 1.

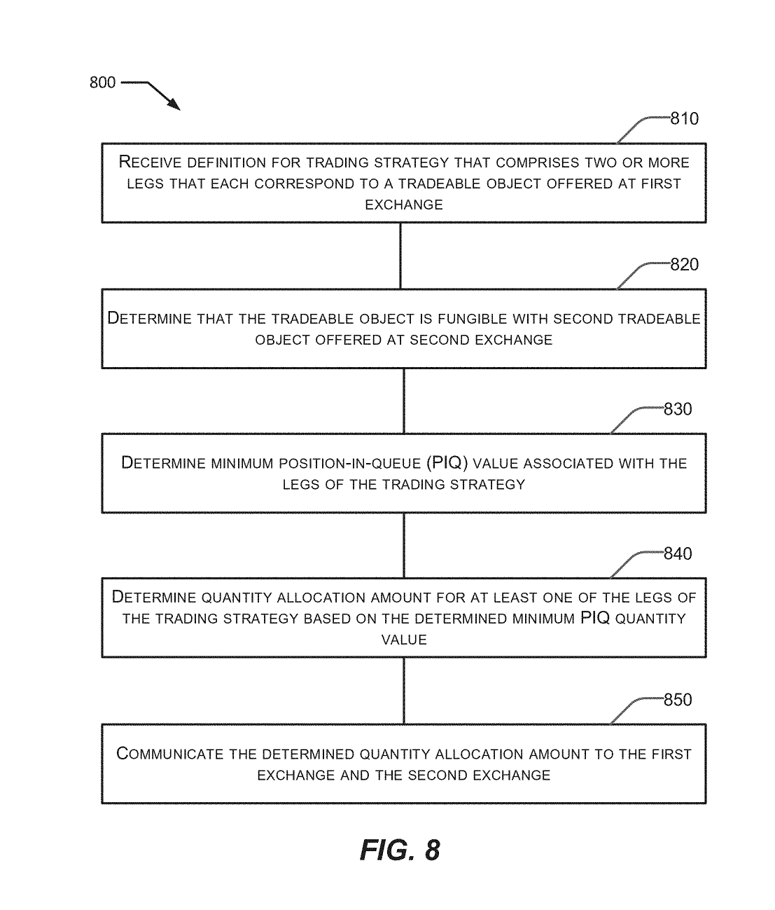

FIG. 8 illustrates a method 800 that may be used to transfer allocated quantities of working orders between exchanges or legs of a trading strategy. The method 800, or portions thereof, may be performed by one or more computing devices, such as a trading device or another computing device. In an example, the method 800, or portions thereof, may be performed by an allocation manager residing at one or more computing devices.

At 810, a definition for the trading strategy is received. The definition may include two or more legs of a trading strategy that correspond to a tradable object offered at a first exchange. For example, an allocation manager may receive the definition for the trading strategy as user input from a trading device. The definition for the trading strategy may specify legs of a synthetic spread that defines tradeable objects that are offered at different electronic exchanges.

At 820, the tradable object offered at an exchange may be determined to be fungible with a tradable object that is offered at another exchange corresponding to another leg of the trading strategy. As used herein, tradeable objects are considered to be fungible if they have the same ticker symbol, contract type, product type, order price, order type (e.g., bid or offer), or if they have a defined relationship established therebetween. Two or more tradeable objects may be of different contract types, product types, and/or durations and may utilize a ratio, and/or multiplier to establish a defined relationship between the objects. For example, three contracts relating to different tradeable objects may have a mathematical relationship defined between each pair of the three tradeable objects. The tradeable objects may be determined to be fungible if they can be traded in substantially the same form (i.e., the size of contract, type of underlying and conditions) across multiple markets offered at one or more exchanges. The tradeable objects are not considered fungible if an order from one leg of the trading strategy would cross the market and result in a fill for a second leg of the same trading strategy.

At 830, a minimum position-in-queue value may be determined among the legs of the trading strategy. The minimum position-in-queue value may be determined as described herein. For example, the minimum position-in-queue value may be determined by evenly distributing the position-in-queue values across each leg or using Equation 1 described herein. Equation 2, below, provides another example of how the minimum position-in-queue value may be determined for each leg of a trading strategy.

Minimum PIQ=(Σ PIQᵢ−Available Order Quantity)/Number of Legs Equation 2

As shown in Equation 2, the minimum position-in-queue value may be determined by taking the sum of the currently pending position-in-queue values for each leg of a trading strategy and subtracting the available contra-side order quantity at a given leg (e.g., the leg that has just received a match), and dividing the result by the number of legs of the trading strategy. Equation 3, below, provides another example of how the minimum position-in-queue value may be determined for each leg.

Minimum PIQ=(Σ PIQᵢ−Σ Available Order Quantitiesᵢ)/Number of Legs Equation 3

As shown in Equation 3, the minimum position-in-queue value may be determined by taking the sum of the currently pending position-in-queue values for each leg of a trading strategy and subtracting the sum of the available contra-side order quantities at each leg, then dividing the result by the number of legs of the trading strategy.

Equation 4, below, provides an example of how the minimum position-in-queue value may take into consideration the rate at which orders may be matched.

Minimum PIQ=Vᵢ*(Σ PIQᵢ−Σ Available Order Quantitiesᵢ)/Number of Legs Equation 4

As shown in Equation 4, the minimum position-in-queue value may be determined by multiplying the rate of trade for each leg (Vᵢ) by the sum of the currently pending position-in-queue values for each leg of a trading strategy minus the sum of the available contra-side order quantities at each leg, then dividing the result by the number of legs of the trading strategy. The rate of trade for each leg (Vᵢ) may, for example, be calculated as a moving average of trades over a fixed period. In certain embodiments, the rate of trade for each leg (Vᵢ) may be calculated continuously, hourly, over the course of a trading session, and/or over ant period of interest to a user. In certain embodiments, the rate of trade for each leg (Vᵢ) may be calculated utilizing trades that meet certain criteria (i.e., trades at the inside market, trades within a defined price band or region, trades that satisfy a quantity threshold).

At 840, a quantity allocation amount is determined for at least one of the legs of the trading strategy based on the determined minimum position-in-queue value. For example, a portion of the allocated quantities from one or more legs may be redistributed to another leg to meet the minimum position-in-queue value for each leg of the trading strategy. The quantity allocation amount to be redistributed may be based on the available order quantity that may be matched by another trade order.

In another example, the quantity allocation amount may be the value of the highest position-in-queue value across the legs. The trade quantity of a leg having the highest position-in-queue value may be moved to the leg having the lowest position-in-queue value.

At 850, the determined quantity allocation amount may be communicated to one or more of the exchanges. For example, an order message may be sent to each exchange to indicate the quantity allocation amount. The order message may include quantity allocation amount parameters that may reduce the allocated quantity that is pending at an exchange by the determined quantity allocation amount. The order message may include quantity allocation amount parameters that may increase the allocated quantity that is pending at an exchange by the determined quantity allocation amount. In one example, the order message may be sent to the exchanges that are affected by the reallocation.

The quantity allocation amount may be prevented from being communicated at 850 if the minimum position-in-queue value and/or the quantity allocation amount is below a threshold. This may prevent reallocation where it may not be worth the transaction costs or to prevent reallocating for quantities smaller than a predefined threshold. The quantity allocation amount may be prevented from being communicated at 850 based on the transaction costs themselves, such as if a transaction cost associated with transferring the quantity allocation amount is above a threshold transaction cost. The transaction cost may be the cost for each transaction on a given exchange. The threshold transaction cost may vary in accordance with the quantity allocation amount. For example, if the quantity allocation amount is below a threshold amount (e.g., less than ten units), the threshold transaction cost may be set to below a threshold cost amount (e.g., free) to justify spending the transaction cost. When the quantity allocation amount is raised to another threshold amount (e.g., more than ten units), the threshold transaction cost may be set to a higher threshold cost amount (e.g., one dollar). When an exchange has no transaction costs, the quantity allocation amounts may be freely communicated.

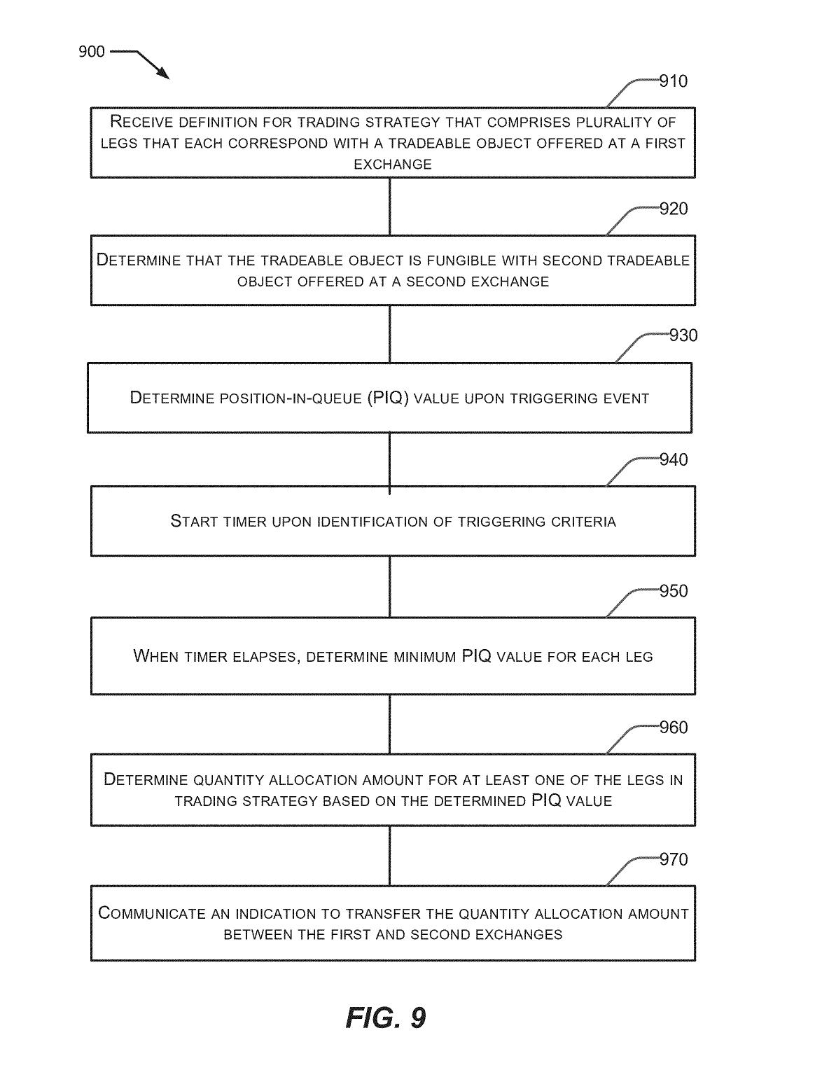

FIG. 9 illustrates a method 900 that may be used to transfer allocated quantities between exchanges or legs of a trading strategy. The method 900, or portions thereof, may be performed by one or more computing devices, such as a trading device or another computing device. In an example, the method 900, or portions thereof, may be performed by an allocation manager residing at one or more computing devices.

At 910, a definition for a trading strategy may be received. The trading strategy may include one or more legs that correspond with the tradable object that may be offered at an exchange. At 920, the tradeable object identified for being reallocated may be determined to be fungible with a tradable object that is offered at another exchange corresponding to another leg of the trading strategy. The minimum position-in-queue value for each leg of a trading strategy may be determined, at 930, when a triggering criteria is determined. For example, a triggering criteria may occur when a minimum position-in-queue value for a leg of the trading strategy reaches a threshold (e.g., zero).

After the allocation manager has determined that a reallocation should be performed to redistribute a trade quantity from one leg to another, the allocation manager may wait a predetermined period of time (e.g., 10 milliseconds) prior to performing the redistribution. At 940, a timer may be started upon the identification of the triggering criteria. The expiration of the period of time set by the timer may be identified, at 950, and the minimum position-in-queue value may be determined for each leg of the trading strategy. The timer may allow updated market data to be received that may affect the decision to reallocate and/or the amount to reallocate. The timer may allow the allocation manager to receive updated market data that indicates that one or more of the other legs of the trading strategy has been matched. After updated market data is received, the allocation manager may determine whether to perform the previously determined redistribution of units, to perform a different redistribution of units, or not perform a redistribution based on the updated market data. For example, the allocation manager may revaluate whether the triggering event is met based on the updated market data. If the allocation manager determines that reallocation should be performed, the quantity allocation amount may be determined, at 960, for one or more legs of the trading strategy based on the minimum position-in-queue value. At 970, an indication may be communicated to one or more exchanges to transfer the quantity allocation amount.

Some of the described figures depict example block diagrams, systems, and/or flow diagrams representative of methods that may be used to implement all or part of certain embodiments. One or more of the components, elements, blocks, and/or functionality of the example block diagrams, systems, and/or flow diagrams may be implemented alone or in combination in hardware, firmware, discrete logic, as a set of computer readable instructions stored on a tangible computer readable medium, and/or any combinations thereof, for example.

The example block diagrams, systems, and/or flow diagrams may be implemented using any combination of application specific integrated circuit(s) (ASIC(s)), programmable logic device(s) (PLD(s)), field programmable logic device(s) (FPLD(s)), discrete logic, hardware, and/or firmware, for example. Also, some or all of the example methods may be implemented manually or in combination with the foregoing techniques, for example.

The example block diagrams, systems, and/or flow diagrams may be performed using one or more processors, controllers, and/or other processing devices, for example. For example, the examples may be implemented using coded instructions, for example, computer readable instructions, stored on a tangible computer readable medium. A tangible computer readable medium may include various types of volatile and non-volatile storage media, including, for example, random access memory (RAM), read-only memory (ROM), programmable read-only memory (PROM), electrically programmable read-only memory (EPROM), electrically erasable read-only memory (EEPROM), flash memory, a hard disk drive, optical media, magnetic tape, a file server, any other tangible data storage device, or any combination thereof. The tangible computer readable medium is non-transitory.

Further, although the example block diagrams, systems, and/or flow diagrams are described above with reference to the figures, other implementations may be employed. For example, the order of execution of the components, elements, blocks, and/or functionality may be changed and/or some of the components, elements, blocks, and/or functionality described may be changed, eliminated, sub-divided, or combined. Additionally, any or all of the components, elements, blocks, and/or functionality may be performed sequentially and/or in parallel by, for example, separate processing threads, processors, devices, discrete logic, and/or circuits.

While embodiments have been disclosed, various changes may be made and equivalents may be substituted. In addition, many modifications may be made to adapt a particular situation or material. Therefore, it is intended that the disclosed technology not be limited to the particular embodiments disclosed, but will include all embodiments falling within the scope of the appended claims.

What is claimed is:

1. A method comprising:
receiving, by an allocation manager, a definition for a trading strategy, wherein the definition comprises a plurality of legs, wherein each of the plurality of legs corresponds with a tradeable object offered at a first exchange;
determining, by the allocation manager, that the tradeable object corresponding to at least one leg specified in the trading strategy is fungible with a second tradeable object offered at a second exchange;
starting, by the allocation manager, a timer when a position-in-queue value associated with one of the legs of the trading strategy is zero;
when the timer has elapsed, determining, by the allocation manager, a minimum position-in-queue value for each leg in the trading strategy;
determining, by the allocation manager, a quantity allocation amount for at least one of the legs of the trading strategy based on the determined minimum position-in-queue value; and
communicating, by the allocation manager, the determined quantity allocation amount to the first exchange and the second exchange, wherein the communication comprises an indication to transfer the determined quantity allocation amount between the first exchange and the second exchange.

2. The method of claim 1, wherein determining the quantity allocation amount further comprises subtracting an available order quantity for the at least one of the legs of the trading strategy.

3. The method of claim 1, wherein determining the minimum position-in-queue value comprises:
calculating, by the allocation manager, a sum of a position-in-queue value for each of the legs of the trading strategy;
calculating, by the allocation manager, a sum of an available contra-side order quantity for each of the legs of the trading strategy;
calculating, by the allocation manager, a difference between the sum of the position-in-queue values and the sum of the available contra-side order quantities; and
calculating, by the allocation manager, the minimum position-in-queue value by dividing the difference between the sum of the position-in-queue values and the sum of the available contra-side order quantities by a number of legs in the trading strategy.

4. The method of claim 1, further comprising:
determining, by the allocation manager, that the tradeable object corresponding to the at least one leg specified in the trading strategy is fungible with a third tradeable object offered at a third exchange;
determining, by the allocation manager, the quantity allocation amount for at least two of the legs of the trading strategy based on the determined minimum position-in-queue value; and
communicating, by the allocation manager, the determined quantity allocation amount to at least two of the first exchange, the second exchange, and the third exchange.

5. The method of claim 1, wherein each of the plurality of legs are part of a synthetic spread.

6. The method of claim 1, wherein the allocation manager is located at a trading device.

7. The method of claim 6, wherein the trading device comprises a trading terminal.

8. The method of claim 6, wherein the trading device comprises a trading server.

9. The method of claim 1, wherein the allocation manager is executed, from memory, by a processor at a computing device.

10. A method comprising:
receiving, by an allocation manager, a definition for a trading strategy, wherein the definition includes two or more legs, wherein each of the two or more legs corresponds to a tradeable object offered at a first exchange;
determining, by the allocation manager, that the tradeable object corresponding to at least one leg specified in the trading strategy is fungible with a second tradeable object offered at a second exchange;
determining, by the allocation manager, a minimum position-in-queue value associated with the legs of the trading strategy;
determining, by the allocation manager, a quantity allocation amount for at least one of the legs of the trading strategy based on the determined minimum position-in-queue value; and
communicating, by the allocation manager, the determined quantity allocation amount to the first exchange and the second exchange.

11. The method of claim 10, wherein determining the minimum position-in-queue value comprises:
calculating, by the allocation manager, a sum of a position-in-queue value for each of the legs of the trading strategy;
calculating, by the allocation manager, a sum of an available contra-side order quantity for each of the legs of the trading strategy;
calculating, by the allocation manager, a difference between the sum of the position-in-queue values and the sum of the available contra-side order quantities; and
calculating, by the allocation manager, the minimum position-in-queue value by dividing the difference between the sum of the position-in-queue values and the sum of the available contra-side order quantities by a number of legs in the trading strategy.

12. The method of claim 10, further comprising:
determining, by the allocation manager, that the tradeable object corresponding to the at least one leg specified in the trading strategy is fungible with a third tradeable object offered at a third exchange;
determining, by the allocation manager, the quantity allocation amount for at least two of the legs of the trading strategy based on the determined minimum position-in-queue value; and
communicating, by the allocation manager, the determined quantity allocation amount to at least two of the first exchange, the second exchange, and the third exchange.

13. The method of claim 10, further comprising determining a transaction cost associated with transferring the determined quantity allocation amount between the first exchange and the second exchange, and wherein the quantity allocation amount is communicated to the first exchange and the second exchange when the determined transaction cost is less than a threshold.

14. The method of claim 10, further comprising:
determining, by the allocation manager, a total available order quantity for the tradeable object at the at least one of the first exchange or the second exchange; and
determining, by the allocation manager, the quantity allocation amount based on the total available order quantity.

15. The method of claim 10, wherein the quantity allocation amount is determined when a triggering criteria is identified.

16. The method of claim 15, further comprising:
starting a timer when the triggering criteria is identified: and
determining whether to adjust the quantity allocation amount after the timer has elapsed.

17. The method of claim 16, wherein the triggering criteria is a position-in-queue value reaching zero for the at least one of the legs of the trading strategy.

18. The method of claim 10, further comprising determining that at least one of the minimum position-in-queue value or the quantity allocation amount is greater than a threshold before communicating the determined quantity allocation amount to the first exchange and the second exchange.

19. The method of claim 10, wherein the two or more legs are a part of a synthetic spread.

20. The method of claim 10, wherein the allocation manager is executed, from memory, by a processor at a trading device.
